(19) United States
(12) Patent Application Publication
(10) Pub. No.: US 2020/0276549 A1
(43) Pub. Date: Sep. 3, 2020

(54) DISPENSING DEVICE, METHOD FOR OPERATING, AND METHOD FOR PROVIDING A FRAGRANCE BLEND

(71) Applicant: NOUSTIQUE PERFUMES, S.L., Barcelona (ES)

(72) Inventors: Jakub Jan JEDLINSKI, WARSZAWA (PL); Hugo LASALA ALONSO, ZARAGOZA (ES); Juan Ramon SOLER COSTA, ZARAGOZA (ES); Alvaro SUAREZ IRIBARNE, BARCELONA (ES)

(21) Appl. No.: 16/761,782

(22) PCT Filed: Nov. 8, 2018
(86) PCT No.: PCT/EP2018/080568

§ 371 Date: May 5, 2020

(30) Foreign Application Priority Data
Nov. 8, 2017 (EP) 17382751.0
Nov. 13, 2017 (EP) 17382764.3

(51) Int. Cl. B01F 15/02; B01F 13/10

(52) U.S. Cl. CPC B01F 15/0237; B01F 13/1058; G06Q 30/0621; B01F 13/1069; B01F 2215/0031; B01F 13/1066

(57) ABSTRACT

A dispensing device (FD; FD2), comprises a cartridge (2) rotatable around a rotational axis (R), the cartridge (2) comprising multiple seats (3; 26) for containers (C); and a stem (29) movable parallel to the rotational axis (R). The cartridge (2) is rotatable such that the seats (3; 26) are individually positionable in line with the stem (29). The dispensing device (FD; FD2) is a fragrance dispenser. A method of providing a fragrance blend (FB) blended from multiple different essences comprises loading a digital formula (DF) of the fragrance blend (FB) to a fragrance dispenser (FD; FD2) wherein the containers (C) hold essences; and by the fragrance dispenser (FD; FD2), dispensing the essences according to the loaded digital formula (DF).

The present application claims the benefit and priority of European patent applications EP17382751, filed on Nov. 8, 2017 and EP17382764, filed on Nov. 13, 2017.

The invention relates to dispensing device, comprising a rotatable cartridge, the cartridge comprising multiple seats for containers; and a stem movable parallel to the rotation axis. The invention also relates to a method for operating the dispensing device. The invention is particularly useful for dispensing devices in form of fragrance dispensers.

Also disclosed is a method of providing a fragrance blend blended or mixed from multiple different essences, and a blending system for blending the fragrance blend according to the method, which are particularly useful for providing individually selected digital formulas of fragrance blends to dispensing device according to the present invention, for example a household or personal fragrance dispenser.

U.S. Pat. No. 6,412,658 B1 discloses a custom cosmetic powder dispensing method, including the steps of providing a body powder dispensing apparatus and operating the body powder dispensing apparatus for dispensing into a container a custom formulation of body powder ingredients at a retail purchase point of sale. The amounts and types of the body powder ingredients dispensed are determined upon specification by a retail customer. The metering device may include a disc rotatable by an actuating arm.

US 2006/124196 A1 discloses a method and an apparatus for the creation and dispensing of a custom formulation within a package at a retail point of sale. In one aspect, US 2006/124196 A1 discloses an automated dispensing apparatus including at least a two-axis robot arm. In another aspect, US 2006/124196 A1 discloses an automated mixer adapted to mix the dispensed custom formulation within the package.

US 2016/107187 A1 discloses a method, computer program product, and apparatus for receiving, at a fluid dispensing apparatus, a control signal, wherein the control signal may be received from a base station, wherein the control signal, when received, may cause the fluid dispensing apparatus to perform operations. The operations may include generating a positive pressure within a fluid cartridge of the fluid dispensing apparatus by adjusting, via a motor of the fluid dispensing apparatus, a drive rod and piston of the fluid dispensing apparatus in a first direction relative to the fluid cartridge to dispense fluid in the fluid cartridge via a nozzle of the fluid dispensing apparatus. The operations may include generating a negative pressure within the fluid cartridge by adjusting, via the motor, the drive rod and piston in a second direction relative to the fluid cartridge to draw fluid into the fluid cartridge via the nozzle.

NZ 607641 A discloses a container system for liquids such as spray fragrances. The system includes a parent container and a child container. The parent container provides a first cavity for confining a liquid, and couples detachably to the child container for refilling the child container through a supply opening in the parent container. The child container can be used for instance as a travel pack in a handbag or hand luggage. Here the child container is a compact dispenser, comprising a bowl-shaped rigid container having a refill opening, which is kept closed by a valve unless the dispenser is connected to the parent container, and a dispensing opening. These openings are located apart from each other. A pump dispenses liquid from the dispense opening. In a particularly simple construction, the opening of the bowl is covered by a deformable membrane to form a closed dispense cavity, the cavity becoming mainly or completely evacuated as the dispensing means is operated. The membrane then relaxes again, filling the dispenser, when the dispenser is re-applied to the parent container.

CN 202687926 U discloses a perfume filling machine, which comprises a support, a towing bracket arranged in the support, a filling frame arranged at the top of the support, more than one injection device arranged on the filling frame, and a perfume box arranged on one side of the support, wherein a pump body is arranged on the right side in the filling frame, the pump body is connected with the perfume box through a conduit, and the pump body is connected with more than one water pipe. According to the utility model, multiple perfumes can be filled simultaneously, so that the filling efficiency is improved.

CN 202400818 U discloses a valve provided with a pipeline and applicable for fragrance sliding way filling. The valve comprises a valve, wherein a handle switch is arranged on the valve; the vale also comprises a pipeline, wherein the valve is arranged on the pipeline; the valve is closed when the handle switch is parallel to the pipeline; and the valve is opened when the handle switch and the pipeline incline. The valve provided with the pipeline is simple in structure and convenient to operate; the accident of fragrance leakage resulted from misopening caused by the collision of the handle when sliding downwards along the sliding way; the environment pollution and the cost are reduced; and meanwhile, the pipeline and the valve are fixedly connected, so that the installation time is reduced, the production efficiency is improved greatly, and the production cost is saved.

U.S. Pat. No. 6371451 B1 discloses a scent diffusion apparatus and method that contains individual original scents for a plurality of scents to be diffused, constructs information on position information of the contained original scents and information on various scents to be diffused in a database, and mixes the original scents of the desired scent properly at a desired point in time based on the scent information, to thereby spray the desired scent. The scent diffusion method includes providing a plurality of scent spraying units containing original scents, heating the original scents via a heater, evaporating the original scents, and diffusing the evaporated scent with the air via an air supply pump. Thus, a desired scent can be transferred to a selected subject under correct concentration. The scent diffusion apparatus uses scent cartridges containing the original scents, such as cartridges used in an existing ink-jet printer, and uses the same control commands as those of a general personal computer or ink-jet printer compatibly. Thus, the scent diffusion apparatus can control an amount of diffusion precisely, be manufactured in a compact fashion, and used in connection with a general-purpose computer in which almost all kinds of operating systems supporting an ink-jet printer are incorporated.

US 2012/247613 A1 discloses a vending machine for dispensing a selected blend of perfumes in response to the deposit of a pre-selected sum of money includes a plurality of containers and a plurality of distinctive scents with one of the scents disposed in each of the containers. A mechanism for selecting one or more of the scents and an amount of one or more of the scents is provided. Further, the vending machine includes a mechanism for blending the selected scents in the selected percentages and providing a sample to a perspective customer. Further, the mechanism includes a slot receiving payment for a quantity of the selected blend together with a delivery process for providing a bottle of the selected perfume to the customer.

US 2016/045838 A1 discloses an aroma substance delivery device adapted to deliver an aroma substance exclusively to the nasal cavities of an individual, comprising the following elements: (i) a source of carrier gas flow; (ii) regulating means which receives the carrier gas flow and regulates its passage through a plurality of channels; (iii) downstream of the regulating means a plurality of aroma substance-containing cartridges, one being associated with each channel, and (iv) disseminating means located in close proximity to the cartridges and adapted to deliver the individual aroma substances from the cartridges to nasal cavities by means of a conduit; there being positioned in each channel on the upstream side and in close proximity to the origin of the channel a flow restrictor, the flow restrictor being configured such that the pressure drop across the flow restrictor is higher than the pressure drop across the rest of the device. The device is particularly useful as an element in conjunction with an audio-visual display, to provide a complete sensory experience.

It is the object of the present invention to at least partially overcome the problems associated with the prior art. It is a particular object of the present invention to provide a user with a robust, compact, precise and/or easy to use dispensing device for dispensing fragrance blends. A further object is to enable a flexible and easy-to-use way to compose a personal fragrance blend.

The objects are achieved according to the features of the independent claims. Advantageous embodiments can be found, e.g., in the dependent claims and/or in the description.

The object is achieved by a dispensing device, comprising: a rotatable cartridge, the cartridge comprising multiple seats for containers; and a rod or stem movable parallel to the rotation axis; wherein the cartridge is rotatable such that the seats are individually positionable in line with the stem; and wherein the dispensing device is a fragrance dispenser.

This dispensing device gives the advantage that it offers a compact design to house and select containers to be seated in the seats. Furthermore, the rotatable cartridge and stem are mechanically robust. Additionally, the use of the stem allows dispensing content of the containers in a very precise manner. Also, use of the dispensing device is easy due to easy exchangeability of the containers.

The dispensing device is adapted to dispense a fragrance blend automatically mixed from content of the containers. The blend can be dispensed into a receptacle (like a bottle, a flacon etc.) or onto a test strip etc. To mix the blend, the dispensing device may comprise a mixing or blending chamber that receives selected amounts of ingredients/content given out from the containers (the idea is not to work with mixing chambers and pipes in order to avoid smell release). Alternatively, the dispensing device may be adapted to directly dispense the ingredients/content into the receptacle or onto the test strip. If directly dispensing into the receptacle, a specific pressure may be used to assure at least some movement of the ingredients/content within the receptacle that achieves a sufficient mixing. To this effect, the release of content from a container is caused by movement of the stem. By the movement, the stem actuates the container, in particular by pushing the container. The released amount is adjustable by the length or distance of the movement of the stem.

The fragrance blend may be a perfume, a cologne etc.

In general, the cartridge may be of any shape that is suitable to be rotated and that allows release of the container's content to be used with a fragrance blend. To achieve a light and easy manufacture of the cartridge, it is advantageous that the cartridge comprises at least one disk-shaped or cylindrical component which comprises the seats.

The cartridge may be rotatable around a rotational/longitudinal axis, in particular around a rotary axle. The rotary axle may be a freely rotating axle or a driven axle (shaft).

To achieve a particularly easy arrangement and operation, the seats may have the same radial distance from the rotational axis. In particular, to be able to use a particularly simple drive mechanism, the seats are arranged at a regular angular distance around the rotational axis.

Generally, the seats and/or the containers may be formed such that the containers are seated or held in the cartridge at a pre-defined longitudinal position or height. This may be achieved by the seats and/or the containers providing end stops with respect to an insertion movement of the containers. In particular, the seats may be holes or bores. Generally, the seats may be identical, or at least two seats are different (e.g. have a different diameter).

For an object (e.g. a container, a seat, an opening etc.) to be positionable in line with the stem may include that this object is in the path or way of movement of the stem. The object may be contacted or may be passed through by the stem, depending on the object's nature and the stem's longitudinal position. For example, if a seat is in line with the stem, the stem may be moved towards the seat. If a container is inserted into the seat, the same holds for the container. In particular, the stem may contact and then push the container to release fluid (e.g., a fragrance, fragrance mix or solvent) from the container. Generally, the stem is movable to mechanically actuate a container in order to release a measured amount of content, in particular liquid, from the container. In particular, this may involve pushing the container, e.g. by compressing a cavity of the container that houses the content.

Additionally or alternatively, the stem may also be adapted to rotate around its axis of linear movement (typically its longitudinal axis). This advantageously allows actuation of a rotatable part of the container, e.g. a spindle drive. In this case, the release of the measured content from the container may achieved by rotating the spindle drive. The stem may be moved into engagement or mesh with the spindle drive and then be rotated to actuate the spindle drive.

It is an embodiment that the cartridge comprises at least two individually rotatable sections or “levels”, in particular rotatable around the same rotational axis, in particular the same rotary axle. This allows packing an especially high number of containers into the cartridge in a compact manner. The levels are positioned one on top of the other, in particular in vertical series.

It is an embodiment that an upper level of the cartridge comprises an opening positioned in line with the stem and formed to let the stem pass through if the upper level is in a pre-determined angular or rotational “feed-through” position. This advantageously allows the stem to move, in the feed-through position, through the upper level towards a lower level, e.g. for actuating a container seated in the lower level in order to release fluid from the container.

It is an embodiment that a lower level of the cartridge comprises an opening formed and positioned in line with the stem if the lower level is in a pre-determined rotational “flow-through” position. This rotational or angular position allows fluid released from a container of an upper level (which is collinear or in line with the stem and the opening of the lower level) to flow or fall through this opening. A lower level thus does not block fluid released from an upper level.

The cartridge may have two or more than two levels one above the other (“stacked levels”). The seats of the different levels may have a similar geometrical arrangement (e.g., the same distance from the rotational axis and/or the same angular distribution) or may have dissimilar geometrical arrangements (e.g., a different distance from the rotational axis and/or a different angular distribution).

It is an embodiment that the levels are disk-shaped levels, e.g. by having a disk-shaped base that comprises the seats. This gives the advantage of a particularly light and cost-effective design.

It is an embodiment that the openings are radial slits. Slits are particularly easy to manufacture. Additionally, slits are difficult to be confused with seats, in particular if the slit is an open slit that starts at an outer rim of the level. The slits may be starting at an outer rim of the level, in particular disk-shaped base. The slits may continue to a central hole of the disk-shaped base. The central hole may be used to attach the base to a rotatory axle. Having a slit that connects the outer rim with the central hole may give the advantage that the level is easily removable from and re-attachable to the rotary axle. The central hole may be dentate.

It is an embodiment that the cartridge, in particular its bottom, is supported by freely rotatable rollers. This achieves a stable and robust arrangement and furthermore gives a high positioning accuracy of the cartridge with respect of the rotational axis. The rollers may be disk-shaped wheels or spherical rollers.

It is an embodiment that the cartridge is rotatable by a drive wheel. This gives the advantage of a low-maintenance and cost-effective rotating means. Additionally, the use of a drive wheel allows easy replacement of the cartridge by a user. The drive wheel may be in frictional engagement with the cartridge, in particular frictional engagement with a lateral rim of the cartridge, in particular of a disk-shaped rim.

It is an embodiment that the cartridge is removable from the dispensing device. Thus, a user may advantageously remove the cartridge from the dispensing device for easy replacement. This may be done to exchange one or more containers before the cartridge is re-inserted into the dispensing device. Alternatively, the cartridge including the containers is replaceable as a unit.

It is an embodiment that the cartridge is removable in one piece, including a rotary axle. This may facilitate replacement of the cartridge, in particular if the cartridge has several levels and/or if the cartridge is tricky to reach.

It is an embodiment that each level of the cartridge is removable from a rotary axle. In this case, the rotary axle may remain in the dispensing device. This is advantageous to be able to only selectively replace a level or containers of a level.

It is an embodiment that containers seating in the seats are individually replaceable with the cartridge remaining in the dispensing device. This allows for a particular simple arrangement.

In both cases, i.e. when the cartridge is removable at least in parts from the dispensing device and/or when containers are individually removable from the dispensing device, the dispensing device may comprise a service opening that allows access to the cartridge and/or container. The service opening may be closable by a door, lid, hatch, or other closing means.

It is an embodiment that the cartridge (in particular including the rotary axle) is removable as a unit together with the closing means. This facilitates replacement of the cartridge and/or containers further. The closing means may acts as a frame holding the rotary axle. To this effect, the closing means may have to arms acting as bearings for the rotary axle.

It is an embodiment that the dispensing device further comprises at least one reader to identify containers seated in the seats. This enables the dispensing device to identify the containers and/or their content. This, in turn, allows presenting only recipes of blends and/or starting ingredients to a user which are actually available. Therefore, the identifying may comprise identifying properties of the container as such (e.g. its type, material, height etc.) and/or of its content.

The type of reader is not restricted and may comprise a code reader, e.g. for reading barcodes and/or QR codes etc., an RFID reader, a NFC reader. The containers may be equipped with respective identification means, e.g. labels. In particular, the reader may also be a writer, e.g. for writing information onto a label.

It is an embodiment that at least one seat, in particular at least two seats, is/are occupied by elongated containers that is/are aligned in parallel to the rotational axis, the elongated container(s) comprising: a hollow cylindrical body; a plunger inserted into the body, the plunger being movable along a longitudinal axis of the body by the stem; a plug fixedly positioned within the body at a longitudinal distance from the plunger such that the body, the plug and the plunger form a cavity; and a channel leading through the plug.

It is an embodiment that at least one seat, in particular at least two seats, is/are occupied by an elongated container/elongated containers that is/are aligned in parallel to the rotational axis, the elongated container(s) comprising: a hollow cylindrical body; a spindle drive housed in the body such that by rotatably actuating the spindle drive liquid is dispensable from a cavity of the container, in particular through a channel leading through a plug confining the cavity.

It is an embodiment that the container further comprises a needle fluidly connected with the channel, a free end of the needle being positioned outside the cavity, and the needle being fully housed within the hollow cylindrical body. By using the integrated needle to dispense fluid from the cavity, this container gives the advantage of a quasi-hermetical sealing of the cavity and thus practically avoids any significant evaporation losses over a long time. Also, the needle enables dispensing particularly precise amount of fluid from the cavity to the outside of the container. Furthermore, fully housing the needle within the body avoids associating the container with conventional syringes used for medical purposes and also prevents users from being pricked. Additionally, the needle is particularly protected against external mechanical loads.

Generally, the dispensing device may comprise one or more stem-and-cartridge units as described above.

It is an embodiment that the dispensing device is a household appliance.

The object is also achieved by a method for operating the dispensing device, in particular by a method for operating the dispensing device having several levels.

In an embodiment at least one container is seated in a seat of the upper level and at least one container is seated in a seat of the lower level. This can be accomplished by a user.

Further, the dispensing device may be instructed to produce a blend from the content of at least two containers. However, in general, the dispensing device may be instructed to dispense content from only one container. This can be accomplished by a user, e.g. via a man machine interface of the dispensing device and/or remotely via a user's computing device like a desktop computer, a laptop computer, a tablet, a smartphone etc. For example, the user may choose to dispense a pre-defined blend and/or may choose certain ingredients/containers to achieve a pre-defined or new blend.

Also, to produce the chosen blend, the dispensing device may automatically rotate the upper level such that a corresponding container is positioned in line with the stem and rotate the lower level such that it is in its rotational flow-through position. In such a configuration, the stem operates or actuates the container of the upper level that is in line with the stem, e.g. by pushing this container or rotating its spindle drive. Subsequently, fluid/content is released from the container. The released fluid falls through the opening of the lower level, e.g. into a chamber for blending and/or dispensing the fluid.

Alternatively or additionally, the dispensing device may rotate the upper level such that it is in its feed-through position and rotate the lower level such that a corresponding container is positioned in line with the stem. In this configuration, the stem is lead through the opening of the upper level such that the stem may further operate or actuate the container of the lower level that is in line with the stem. Subsequently, fluid/content is released from this container. The released fluid may fall into the blending chamber or may be directly dispensed, e.g. into a receptacle or onto a test strip.

In both configurations, the dispensing device brings the stem in contact with the container in line with the stem to release fluid from this container. In particular, the dispensing device may move the stem onto the container in line with the stem to push a plunger of this container into its body or to rotate a spindle drive.

The rotation of the cartridge and the operating of the stem and thus the release of fluid from the containers may be accomplished in sequential order for each selected container from a cartridge. Generally, this principle can be extended to more than two levels. Generally, the principle of a rotation of the cartridge and of operating the stem to release of fluid from the containers may also be applied to a cartridge containing only one level.

Also disclosed is a method of providing a fragrance blend blended or mixed from multiple different essences, the method comprising: loading a digital formula of the fragrance blend, especially from a database and preferably via the Internet, to a fragrance dispenser such as disclosed above, wherein the containers hold the essences; and, by the fragrance dispenser, dispensing the essences according to the loaded digital formula. The loading may be initiated by an end user device. In the context of this description, loading may also mean downloading and downloading may also mean loading.

This method gives the advantage that an end user can dispense a personal fragrance blend based on a loaded, especially downloaded, digital formula. That the fragrance blend is blended based on multiple essences—typically a sub-group of all available essences—allows a particularly high number of potential combinations of essences to produce a large variety of fragrance blends (as opposed to a fragrance dispenser comprising containers holding already final fragrance blends). Furthermore, this method potentially enables an end user to get a personal fragrance blend wherever there is a fragrance dispenser of the described sort.

The fragrance blend may be a “fine fragrance” like a perfume (perfume extract, pure perfume), an Esprit de Parfum, an Eau de Parfum, an Eau de Toilette, an Eau de Cologne, etc., comprising the mix of the multiple different essences and potentially additional solvent(s). The fragrance blend may also be a cosmetic product (e.g. a skin cream, shampoo, etc.) comprising the mix of the multiple different essences.

An essence may comprise a mixture of one or more aroma compounds and one or more solvents. In particular, an essence may comprise one or more scents or olfactory components. In particular, an essence may correspond to the content of a container that can be stored in the dispensing appliance to be dispensed from the dispensing appliance.

The dispensing appliance may be a household appliance. This gives the advantage that a personal fragrance good may be composed by an end user, e.g. at home or at particular premises like at an office space, at public restrooms etc. In particular, a fragrance blender can potentially be used by many different end users. The dispensing appliance can also be located in a shop, e.g. in a perfumery or a drugstore.

The database may be a hosted on one or more servers and/or may be a distributed database like a cloud storage. The use of the database also allows tracking of use of the digital formulas and pricing per single millilitre of created final personal fragrance blends etc.

The digital formula may comprise all necessary parameters to blend the respective fragrance blend, e.g. identifiers (ID), amounts or ratios, and dilutions/saturations of the essences to be mixed to give the fragrance blend.

The end user device may be a user's computer like a desktop computer or a laptop computer. The end user device may also a personal handheld device like a smartphone, a tablet computer, etc.

Initiating downloading may comprises all steps necessary to allow actual downloading of the digital formula.

That the fragrance dispenser comprises containers holding the essences includes that the dispensing appliance is adapted to store several containers at the same time with each container comprising one essence. The dispensing appliance may comprise one or more dedicated solvent tanks to adjust a dilution of the essences and the fragrance blend.

It is an embodiment that the fragrance dispenser blends the essences before dispensing them. This gives the advantage that a particularly uniformly olfactory experience can be achieved. Alternatively, the fragrance dispenser separately dispenses the essences onto the same area of a target, e.g. a test strip. In this case, the essences are mixed together outside the fragrance dispenser.

It is an embodiment that initiating the downloading comprises authorising the downloading from a digital store upon request of the end user and the end user device, respectively. It is an embodiment that the authorising comprises buying the digital formula from the digital store via the end user device. This gives the advantage that creators of digital formulas can be paid for their efforts, and a marketplace for personal fragrance blends can be created. Additionally to buying a digital formula, the authorising may be achieved by selecting a free digital formula, by redeeming a gift voucher etc. The authorising may include issuing a download code or a download link and/or may include providing an instant download possibility, e.g. a one-click-download.

It is an embodiment that a description to the digital formula is stored in the database. This gives the advantage that a user can read the description in “prose” to get an impression of the fragrance blend. For example, the description may comprise a verbal description, one or more images, one or more references, one or more web links etc.

It is an embodiment that descriptions stored in the database are presented by the digital store; and that authorising downloading from the digital store upon request of the end user and end user device, respectively, comprises selecting the description by the end user and end user device, respectively. The end user may thus advantageously select a digital formula based on its description. The end user may also browse the descriptions stored in the database. The descriptions may be allowed to be saved to/stored in the end user device.

The digital formula and the description may form a “digital recipe”. In particular, the database may store a multitude of digital recipes, providing the digital store with the descriptions and downloading the respective digital formulas to a fragrance dispenser.

It is an embodiment that downloading the digital formula from the database to the fragrance dispenser comprises directly downloading the digital formula from the database to the fragrance dispenser.

It is an additional or alternative embodiment that downloading the digital formula from the database to the fragrance dispenser comprises indirectly downloading the digital formula from the database to the fragrance dispenser via the end user device. The end user device then acts as a bridge between the database and the fragrance dispenser.

For example, the user may download the digital formula onto his computer and store it on a memory stick or a memory card. With this memory stick or memory card he may go into a shop with a fragrance dispenser, put his memory stick or memory card into the fragrance dispenser and print out his favourite fragrance described by the digital formula.

In an alternative example, the user may download the digital formula onto his smartphone, where it is stored. When he is in a shop with a fragrance dispenser, he may transmit the digital formula from his smartphone to the fragrance dispenser, e.g. via Bluetooth or Wifi, such that the fragrance described by the digital formula can be dispensed by the fragrance dispenser.

The digital formula may be persistently stored in the end user device and/or the fragrance dispenser. Alternatively, the digital formula may be erased after dispensing the fragrance blend a pre-defined number of times. Alternatively, the digital formula may be streamed to the fragrance dispenser for dispensing the fragrance blend without possibility of persistent storage. The usage of the digital formula may be restricted by a digital rights management system that preferably warrants that the user is charged for each usage of the digital formula.

Also disclosed herein is a blending system for blending the fragrance blend according to the method as described above, the blending system at least comprising the co-ordination entity and the fragrance dispenser. The co-ordination entity may comprise: at least one first communication interface adapted to receive digital formulas and preferably respective descriptions, a database adapted to store the received digital formulas and preferably respective descriptions, a digital store preferably adapted to present the stored descriptions and to authorise downloading of a digital formula for which a respective description has been selected preferably by an end user device connectable to the co-ordination entity and a second communication interface adapted to load or download digital formulas and potentially respective descriptions to a fragrance dispenser specified preferably by the end user device. The fragrance dispenser may be adapted to load or download at least one digital formula and potentially at least one respective description from the co-ordination entity and to dispense multiple essences specified by the at least one digital formula.

The at least one first communication interface may include a CMS (“Content Management System”) interface for commercial users. The CMS interface allows, amongst other possibilities, for multiple uploads and management of digital recipes. The at least one first communication interface may also include an individual user interface (e.g. a mobile app or a website access) for individual end users to upload and eventually manage their digital recipes. Generally, the at least one first communication interface may allow browsing, managing, sharing, and altering one's own digital recipe(s) as well as composing new digital recipe(s) etc.

It is an embodiment that the fragrance dispenser comprises a cartridge rotatable around a rotational axis, the cartridge comprising multiple seats for containers. In particular, the fragrance dispenser may also comprise a stem movable parallel to the rotational axis; wherein the cartridge is rotatable such that the seats are individually positionable in line with the stem.

It is an embodiment of the fragrance dispenser that the cartridge comprises at least two levels individually rotatable around the rotational axis; wherein an upper level comprises an opening positioned in line with the stem and formed to let the stem pass through if the upper level is in a pre-determined rotational feed-through position; and wherein a lower level comprises an opening formed and positioned in line with the stem if the lower level is in a pre-determined rotational flow-through position.

It is an embodiment of the fragrance dispenser that the levels are disk-shaped levels.

It is an embodiment of the fragrance dispenser that the openings are radial slits.

It is an embodiment of the fragrance dispenser that the cartridge is supported by freely rotatable rollers.

It is an embodiment of the fragrance dispenser that the cartridge is rotatable by a drive wheel.

It is an embodiment of the fragrance dispenser that the cartridge is removable from the fragrance dispenser.

It is an embodiment of the fragrance dispenser that the cartridge is removable in one piece, including a rotary axle.

It is an embodiment of the fragrance dispenser that each level of the cartridge is removable from a rotary axle.

It is an embodiment of the fragrance dispenser that containers seating in the seats are individually replaceable with the cartridge remaining in the fragrance dispenser.

It is an embodiment of the fragrance dispenser that the fragrance dispenser further comprises at least one reader to identify containers seated in the seats. This gives the advantage that all essences present in the fragrance dispenser are known and may be reported to the database and/or to an end user device. Additionally, the fragrance dispenser may be adapted to determine a (residual) quantity (volume) of the essences stored in the containers. This gives the advantage that this quantity may be reported to the end user device. A user may decide to buy a new container, if the quantity is low.

It is an embodiment of the fragrance dispenser that at least one seat is occupied by a respective elongated container that is aligned in parallel to the rotational axis, the at least one elongated container comprising: a hollow cylindrical body; a plunger inserted into the body, the plunger being movable along a longitudinal axis of the body by the stem; a plug fixedly positioned within the body at a longitudinal distance from the plunger such that the body, the plug and the plunger form a cavity; and a channel leading through the plug.

It is an embodiment of the fragrance dispenser that the container further comprises a needle fluidly connected with the channel, a free end of the needle being positioned outside the cavity, and the needle being fully housed within the hollow cylindrical body.

The fragrance dispenser may be operated such that at least one container is seated in a seat of the upper level and at least one container is seated in a seat of the lower level; the fragrance dispenser is instructed to produce a blend from the content of at least two containers; the fragrance dispenser rotates the upper level such that a corresponding container is positioned in line with the stem and rotates the lower level such that it is in its rotational flow-through position and/or the fragrance dispenser rotates the upper level such that it is in its feed-through position and rotates the lower level such that a corresponding container is positioned in line with the stem; and the fragrance dispenser then pushes the stem onto the container in line with the stem to release liquid essence from this container.

The above described features may be freely recombined to generate further embodiments. If not stated otherwise, features of one claim category (method, system, fragrance dispenser etc.) are also applicable to all other claim categories (method, system, fragrance dispenser etc.).

The above described features and advantages of the invention as well as their kind of implementation will now be schematically described in more detail by at least one embodiment in the context of one or more figures.

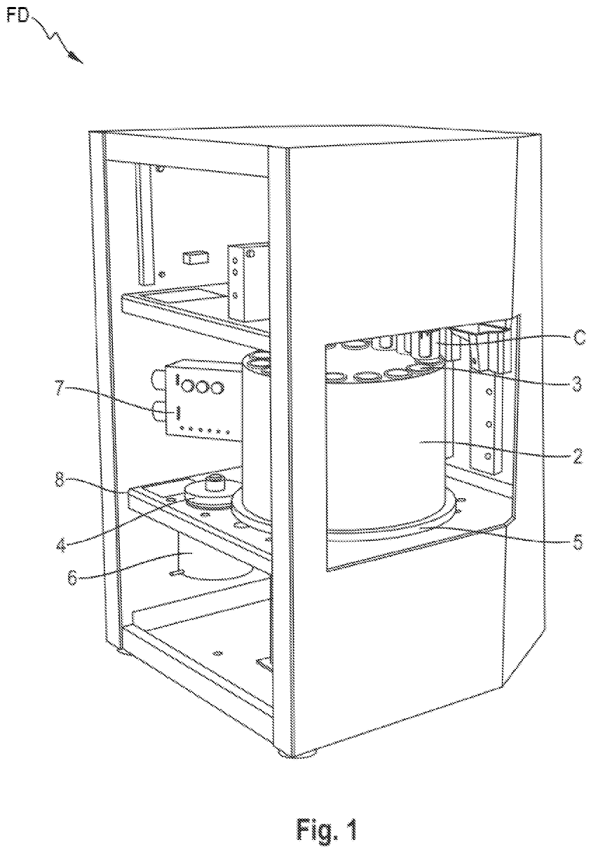

FIG. 1 shows an oblique view of a dispensing device comprising a cartridge according to a first embodiment;

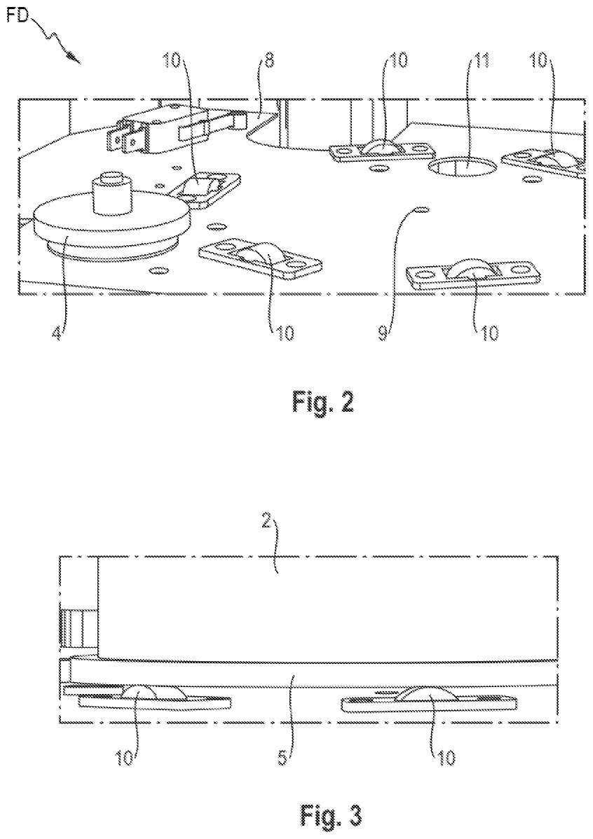

FIG. 2 shows an oblique view of an enlarged cut-out of the dispensing device of FIG. 1;

FIG. 3 shows a side view of an enlarged cut-out of the dispensing device of FIG. 1;

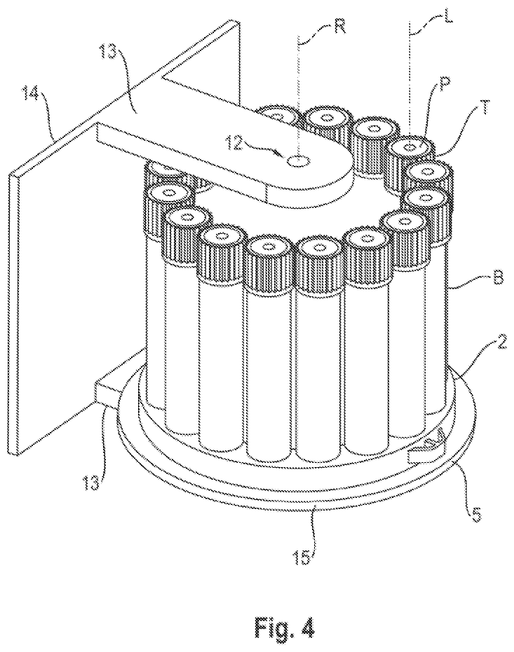

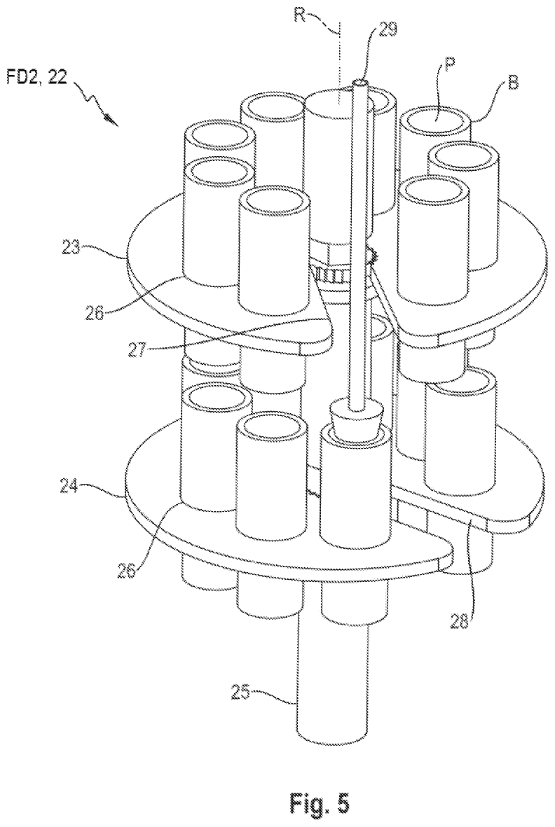

FIG. 4 shows an oblique view of the cartridge filled with the containers according of FIG. 1;

FIG. 5 shows an oblique view of a cartridge filled with containers according to a second embodiment of a dispensing device;

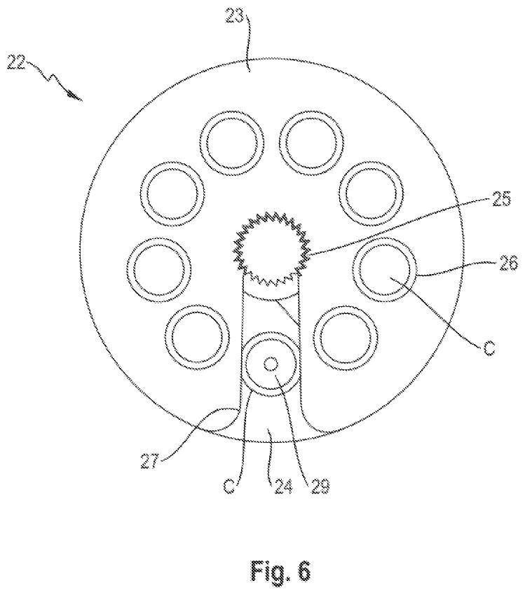

FIG. 6 shows a top-down view of the cartridge of FIG. 5;

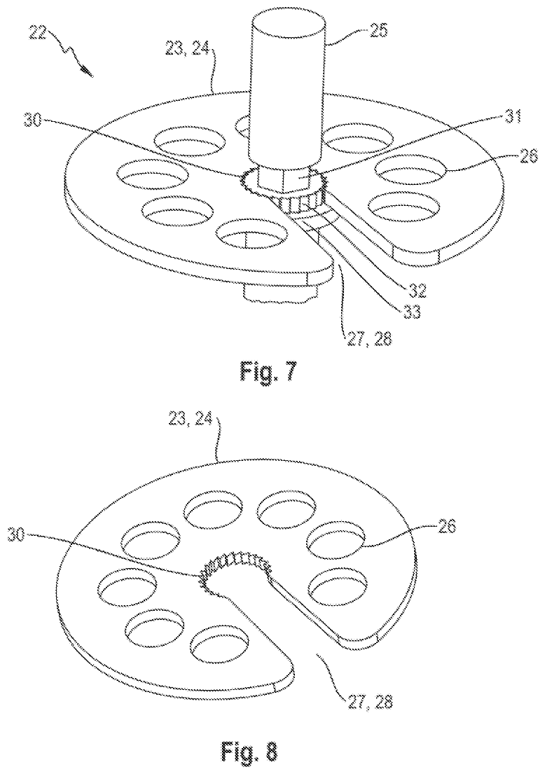

FIG. 7 shows an oblique view of one level of the cartridge of FIG. 5 with a rotary axle;

FIG. 8 shows an oblique view of the one level of the cartridge of FIG. 5 without the rotary axle; and

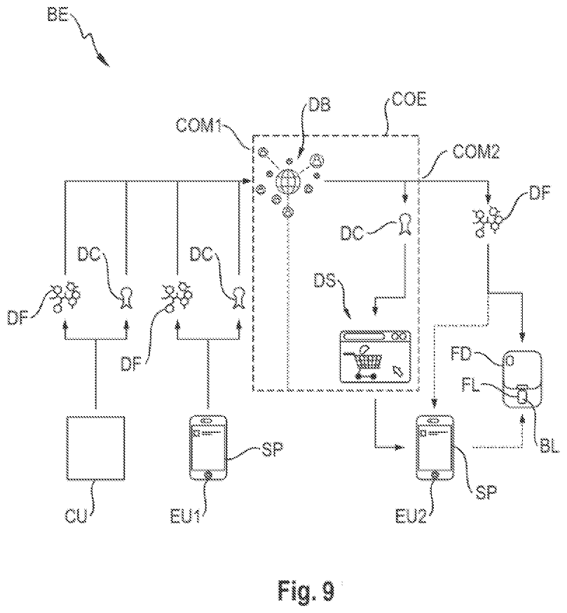

FIG. 9 shows a blending environment for blending a fragrance blend.

FIG. 1 shows an oblique view of a dispensing device FD comprising a cartridge 2 partially filled with cylindrical containers C according to a first embodiment. The dispensing device FD may be a fragrance dispenser. The dispensing device FD may be a household appliance.

The cartridge 2 is of a cylindrical form and rotatable around a rotational axis R (see FIG. 4) that coincides with its longitudinal axis. The cartridge 2 and its rotational axis R, respectively, are vertically aligned within the dispensing device FD.

The cartridge 2 comprises multiple holes that are aligned in parallel to the rotational axis and that serve as seats 3 for the containers C. The seats 3 are arranged in angular symmetry around the rotational axis, in particular having the same radial distance from the rotational axis R and a uniform angular distribution. The seats 3 are formed to hold the containers C in vertical alignment and at the same height. If the containers C have the same length, they stick out of the top of the cartridge 2 at the same height. In particular, all seats 3 may have the same form.

The cartridge 2 is rotatable around the rotational axis R by a drive wheel 4 that is frictionally engaged with a lateral circular surface of the cartridge 2, namely with a laterally protruding circular rim 5. The drive wheel 4 is driven by a motor 6, e.g. an electric stepping motor 6. The stepping motor 6 is operable to rotate the cartridge 2 such that the positions of the containers C are stepwise altered. This can also be described as a revolver-type rotation.

The dispensing device FD also comprises a stem 29 (see FIG. 5) which may be linearly moved in parallel to the rotational axis R but has a fixed lateral or perpendicular position with respect to the rotational axis R. One of the seats 3 is in line with the stem 29 such that the stem 29 can be lowered towards this seat 3. If the seat 3 seats a container C, the stem may contact the container C to release a measured amount of fluid from the container C, for example an essence. To achieve a precise dosage of the fluid, the stem 29 is movable and/or is rotatable in a continuous or quasi-continuous manner.

By rotating the cartridge 2, one or more containers C are selectable to release their fluid/content, for example the essence, in particular from their bottom side. Thus, the cartridge 2 is rotatable such that the seats 3 are individually positionable in line with the stem 29.

The dispensing device FD further comprises a reader 7 (e.g., a barcode reader) to identify the containers C and/or their ingredient(s). The reader 7 may be coupled to a control unit (not shown) of the dispensing device FD.

FIG. 2 shows an oblique view of an enlarged cut-out of the dispensing device FD. The cut-out shows a compartment floor 8 that has a hole 9 for inserting a respective pin of a rotary axle of the cartridge 2 or of a bracket or frame thereof. Placed in radial symmetry around this hole 9 is a set of freely rotatable rollers in form of wheels 10.

The wheels 10 are adapted to support the bottom surface of the cartridge, as can be seen in FIG. 3.

FIG. 2 also shows a through-hole 11 through which liquid released from a container C may fall or flow, e.g. into a blending chamber (not shown).

FIG. 4 shows an oblique view of the cartridge 2 filled with the containers C while a lateral side wall is not shown. A rotary axle 12 of the cartridge 2 rotational around the rotational axis L is inserted into a pair of arms 13. The cartridge 2 is freely rotatable with respect to the arms 13.

The arms 13 are held together by a cover 14. The arms 13 and the cover 14 act as a frame for the rotary axle 12. The cover 14 is used to close a service opening (not shown) of the dispensing device FD. The lower arm 13 has a pin (not shown) at its lower side that can be inserted into the hole 9 for improved positional accuracy. When the cover 14 is removed, the cartridge 2 is removed with is, including the rotary axle 12. This facilitates replacement of the containers C.

Replacement of the containers C may include removing the cartridge 2 from the dispensing device FD and re-inserting the cartridge 2 into the dispensing device FD. The replacement of the containers C may be performed in one or more of several ways:

In one variant, the complete unit including the cover 14, the arms 13, the cartridge 2, and the containers C is replaced.

In another variant, the cartridge 2 is disengaged from the arms 13 and is replaced together with the containers C.

In yet another variant, the cartridge 2 may or may not remain engaged with the arms 13, and a user replaces the containers C, in particular individually. Particularly in this variant, the user may detach the lateral side wall to replace the containers C. The containers C are then only seated in seats of a disk-shaped base 15 of the cartridge 2.

In all these variants, the cartridge 2 is removed from the dispensing device FD in one piece.

In even another variant (not shown), only the cartridge 2 and the containers C are removable from the dispensing device FD for replacement of the containers C.

Alternatively, the containers C are individually replaceable with the cartridge 2 remaining in the dispensing device (not shown). This may be facilitated by using a tap located in the middle of cover 14 such that the cartridge 2 may be rotated accordingly to put an empty container C at the tap.

The containers C are aligned in parallel to the rotational axis L. The containers C comprise a hollow cylindrical body B; a plunger P inserted into the body B, the plunger P being movable along a longitudinal axis L of the body B by the stem. For new containers C, the plunger P is positioned at or near the top face of the body B. The containers C further comprise a plug (not shown) fixedly positioned within the body B at a longitudinal distance from the plunger P such that the body B, the plug and the plunger P form a cavity (not shown); and a channel (not shown) leading through the plug towards a bottom face of the body B. The cavity is filled with fluid, e.g. a liquid essence, for example to be used in blending a fragrance blend. The fluid may comprise a fragrance, a fragrance mix and/or solvent. The blend may be a perfume, an Eau de Cologne etc., as chosen by the user. On the outside of its top section T, the body B is structured (here: dentate) to allow a safe grip by a user to handle the containers C.

FIG. 5 shows an oblique view of a cartridge 22 of a dispensing device FD2, for example a fragrance dispenser, filled with containers C. The containers C may be the same containers as described for the first embodiment.

The cartridge 22 comprises two sections or levels 23 and 24 positioned one above the other. The levels 23 and 24 are individually rotatable around the rotation axis R. To this effect, the levels 23 and 24 may be rotatable around the same rotary axle 25 or around two collinear rotary axles. In the present embodiment, the configuration having only one rotary axle 25 is shown. This rotary axle 25 may have two or more sections that are freely rotatable around the rotation axis R.

The levels 23 and 24 may be rotatable by respective motors, e.g. via respective drive wheels (not shown).

Both levels 23, 24 comprise multiple (here: eight) seats 26 in form of holes into which the containers C are insertable. The seats are uniformly distributed around the rotational axis R. The seats 26 and the containers C may be formed such that a stop is provided to position the containers C at a pre-defined height with respect to the levels 23, 24. Both levels 23, 24 further comprise openings in form of linear radial slits 27 and 28, respectively. Both levels 23, 24 are basically disk-shaped and may be identical in shape.

To release fluid, such as essence, from a container C seated in a seat 26 of the lower level 24, the dispensing device FD2 rotates the upper level 23 such that it is in its feed-through position in which the upper slit 27 is in line with the stem 29. Thus, the stem 29 may pass through the upper slit 27. Furthermore, the dispensing device FD2 rotates the lower level 24 such that a desired container C is in line with the stem 29. The dispensing device FD2 then pushes the stem 29 onto this container C in line with the stem 29, e.g. to push its plunger P into its body B to release fluid from this container C, as shown. FIG. 6 shows a top-down view of the cartridge 22 in this position.

To release fluid, such as essence, from a container C seated in a seat 26 of the upper level 23, the dispensing device FD2 rotates the upper level 23 such that a corresponding container C is positioned in line with the stem 29 and rotates the lower level 24 such that it is in its rotational flow-through position in which the lower slit 28 is in line with the stem 29 and thus below the container C to be actuated (not shown).

FIG. 7 shows an oblique view of one level 23 or 24 of the cartridge 22 with the rotary axle 25. FIG. 8 shows an oblique view of the one level 23 or 24 without the rotation axis.

To fix the levels 23 and 24 of the cartridge 22 to the rotary axle 25, the levels 23 and 24 have a central hole 30 that is dentate. The slits 27 and 28, respectively, connect the central hole 30 with the outer rim of the levels 23 and 24, respectively.

To attach the levels 23 and 24 to the rotary axle 25, the rotary axle 25 comprises a butted section 31 of smaller diameter than the slits 27, 28. Below the butted section 31 is a dented section 32 of the axle 25 that is form to closely fit into the central hole 30. The engaging teeth of the central hole 30 and of the dented section 32 prevent rotation of the levels 23 and 24 around the axle 25.

Below the dented section 32 is a laterally extending flange 33 that acts as a support and longitudinal stop for the levels 23, 24.

To remove a level 23, 24 of the cartridge 22 from the rotary axle 25 (e.g. to replace containers C), a user may first lift the level(s) 23, 24 to the respective butted section 31 and then slide it off the axle 25 though the slit 27, 28. To insert the level 23, 24, the reverse steps can be performed.

FIG. 9 shows a blending environment BE for blending a fragrance blend BL. The fragrance blend BL may be blended by a dispensing device such as a fragrance dispenser FD, for example a dispensing device according to any one of the embodiments herein, and then filled into a receptacle like a flacon FL etc. To this effect, the fragrance dispenser FD may comprise a blending chamber (not shown).

The fragrance dispenser FD is a networked device and may comprise one or more data communication interfaces (not shown) for wireless and/or wire-bound communication, e.g. a WLAN adapter, an Ethernet adapter etc.

The fragrance dispenser FD may be communicatively coupled with personal devices of end users EU2, e.g. smartphones SP. The fragrance dispenser FD may also be communicatively coupled with a co-ordination entity COE. The co-ordination entity COE may comprise a database DB as a backend and a digital store DS as a front end. End users EU2 may, e.g. via their smartphones SP, access the digital store DS.

In the database DB is stored a digital library that comprises a multitude of “digital recipes” DF, DC of fragrance blends BL. Each digital recipe DF, DC comprises a digital formula DF giving parameters defining the respective fragrance blend BL, e.g. identifiers (ID), amounts and dilutions of essences to be mixed to give the fragrance blend BL. Each digital recipe DF, DC also comprises a description DC describing the fragrance blend BL and potentially its applications to an end user EU2. The description DC may by written in easily understandable “prose”.

The digital recipes DF, DC may be uploaded into the database DB by commercial users CU and by end users EU1, e.g. via a first communication interface COM1. For example, an end user EU1 may upload a digital recipe DF, DC via a smartphone SM, alternatively via a fragrance dispenser FD.

In the co-ordination entity COE, the descriptions DC are made available to the digital store DS. An end user EU2 may browse the digital store DS for the descriptions DC. If the end user EU2 finds a description DC that he or she likes, he or she may initiate downloading the respective digital formula DF, e.g. by selecting for downloading a free digital recipe DF, DC and/or by buying a digital recipe DF, DC. This includes authorising to download a respective digital formula DF.

If downloading has been initiated (and authorized) for a certain digital recipe DF, DC, the respective digital formula DF is downloaded (pushed or requested) to a fragrance dispenser FD selected by the end user EU2, e.g. via a second communication interface COM2 of the co-ordination entity COE. This downloading may be via a direct communication between the co-ordination entity COE and the fragrance dispenser FD, or via the end user EU2, as indicated by the dashed arrows. The fragrance dispenser FD may then produce the fragrance blend BL by dispensing the potentially multiple essences as defined by the downloaded digital formula DF.

The downloaded digital formula DF may be quasi-permanently stored in the fragrance dispenser FD or may have to be downloaded or streamed from the database DB every time a dispensing process is activated.

The co-ordination entity COE and the fragrance dispenser FD may form or constitute a blending system COE, FD.

Of course, the invention is not restricted to the described embodiments.

### LIST OF REFERENCE SIGNS

FD Fragrance dispenser

FD2 Fragrance dispenser

2 Cartridge

3 Seat

4 Drive wheel

5 Rim

6 Motor

7 Reader

8 Compartment floor

9 Hole

10 Wheel

11 Through-hole

12 Rotary axle

13 Arm

14 Cover

15 Base

22 Cartridge

23 Upper level

24 Lower level

25 Rotary axle

26 Seat

27 Upper radial slit

28 Lower radial slit

29 Stem

30 Central hole

B Body of the container

C Container

P Plunger of the container

R Rotational axis

L Longitudinal axis

BE Blending environment

BL Fragrance blend

COE Co-ordination entity

COM1 First communication interface

COM2 Second communication interface

CU Commercial user

DB Database

DC Description

DF Digital formula

EU1 End user

EU2 End user

FL flacon

SP Smartphone

1. A dispensing device, comprising a cartridge rotatable around a rotational axis, the cartridge comprising multiple seats for containers; and
a stem movable parallel to the rotational axis;
wherein
the cartridge is rotatable such that the seats are individually positionable in line with the stem; and wherein the dispensing device is a fragrance dispenser.

2. The dispensing device according to claim 1, wherein the comprises at least two levels individually rotatable around the rotational axis; wherein
an upper level comprises an opening positioned in line with the stem and formed to let the stem pass through if the upper level is in a pre-determined rotational feed-through position; and wherein
a lower level comprises an opening formed and positioned in line with the stem if the lower level is in a pre-determined rotational flow-through position.

3. The dispensing device according to claim 2, wherein the levels are disk-shaped levels.

4. The dispensing device according to claim 2, wherein the openings are radial slits.

5. The dispensing device according to any of tho claim 1, wherein the cartridge is supported by freely rotatable rollers.

6. The dispensing device according to claim 1, wherein the cartridge is rotatable by a drive wheel.

7. The dispensing device according to claim 1, wherein the cartridge is removable from the dispensing device.

8. The dispensing device according to claim 7, wherein the cartridge is removable in one piece, including a rotary axle.

9. The dispensing device according to claim 2, wherein each level of the cartridge is removable from a rotary axle.

10. The dispensing device according to claim 1, wherein containers seating in the seats are individually replaceable with the cartridge remaining in the dispensing device.

11. The dispensing device according to claim 1, wherein the dispensing device further comprises at least one reader to identify containers seated in the seats.

12. The dispensing device according to claim 1, wherein at least one seat is occupied by a respective elongated container that is aligned in parallel to the rotational axis, the at least one elongated container comprising:
a hollow cylindrical body;
a plunger inserted into the body, the plunger being movable along a longitudinal axis of the body by the stem;
a plug fixedly positioned within the body at a longitudinal distance from the plunger such that the body, the plug and the plunger form a cavity; and
a channel leading through the plug.

13. The dispensing device according to claim 12, wherein the container further comprises a needle fluidly connected with the channel, a free end of the needle being positioned outside the cavity, and the needle being fully housed within the hollow cylindrical body.

14. (canceled)

15. A method for operating the dispensing device according to claim 1, wherein
at least one container is seated in a seat of the upper level and at least one container is seated in a seat of the lower level;
the dispensing device is instructed to produce a blend from the content of at least two containers;
the dispensing device rotates the upper level such that a corresponding container is positioned in line with the stem and rotates the lower level such that it is in its rotational flow-through position and/or the dispensing device rotates the upper level such that it is in its feed-through position and rotates the lower level such that a corresponding container is positioned in line with the stem; and
the dispensing device then pushes the stem onto the container in line with the stem to release fluid from this container.

16. A method of providing a fragrance blend blended from multiple different essences, the method comprising:
loading or downloading a digital formula of the fragrance blend to a fragrance dispenser according to claim 1, wherein the containers hold essences; and,
by the fragrance dispenser, dispensing the essences according to the loaded digital formula.

17. (canceled)

18. (canceled)

19. The method according to claim 16, wherein the fragrance dispenser blends the essences before dispensing them.

20. (canceled)

21. (canceled)

22. The method according to claim 16, wherein a description of the digital formula is stored in the a database and is presented by a digital store; and additionally comprising authorizing downloading from the digital store upon request by selecting the description.

23. (canceled)

24. (canceled)

25. The method according to claim 16, wherein the downloading the digital formula from the a database to the fragrance dispenser comprises indirectly downloading the digital formula from the database to the fragrance dispenser via an end user device.

26. A blending system for blending the fragrance blend according to the method of claim 16, the blending system comprising at least:
a co-ordination entity, the co-ordination entity comprising
at least one first communication interface adapted to receive digital formulas and respective descriptions,
a database adapted to store the received digital formulas and respective descriptions,
a digital store adapted to present the stored descriptions and to authorise authorize downloading of a digital formula for which a respective description has been selected, and
at least one second communication interface adapted to load or download digital formulas and potentially respective descriptions to a fragrance dispenser,
the fragrance dispenser, adapted to load or download at least one digital formula and potentially at least one respective description and to dispense multiple essences specified by the at least one digital formula.

27. The blending system according to claim 26, wherein the fragrance dispenser comprises a cartridge rotatable around a rotational axis, the cartridge comprising multiple seats for containers.
